(19) United States
(12) Patent Application Publication
(10) Pub. No.: US 2024/0128561 A1
(43) Pub. Date: Apr. 18, 2024

(54) OUTER SHELL STRUCTURE AND BATTERY

(71) Applicant: Zhuhai CosMX Battery Co., Ltd., Zhuhai (CN)

(72) Inventors: Zhida WEI, Zhuhai (CN); Ning PENG, Zhuhai (CN)

(21) Appl. No.: 18/397,963

(22) Filed: Dec. 27, 2023

Related U.S. Application Data
(63) Continuation of application No. PCT/CN2022/102152, filed on Jun. 29, 2022.

(30) Foreign Application Priority Data
Dec. 6, 2021 (CN) 202123056292.5

(51) Int. Cl. H01M 50/202; H01M 50/233; H01M 50/296; H01M 50/383; H01M 50/55; H01M 50/553

(52) U.S. Cl. CPC H01M 50/202; H01M 50/233; H01M 50/296; H01M 50/383; H01M 50/55; H01M 50/553

(57) ABSTRACT

The present application discloses an outer shell structure and a battery, the outer shell structure is used for carrying a battery cell. The outer shell structure includes a cover plate, a bottom plate and a shell body, where each of two opposite ends of the shell body both has an opening, the cover plate and the bottom plate cover on the two opposite sides of the shell body respectively; the cover plate, the shell body and the bottom plate together enclose to form an accommodation chamber for accommodating the battery cell; and the outer shell structure includes a conductive assembly disposed on the shell body. The present utility model improves the effective volume of the accommodation chamber of the battery and energy density of the battery.

### CROSS-REFERENCE TO RELATED APPLICATIONS

This application is a continuation of International Application No. PCT/CN2022/102152, filed on Jun. 29, 2022, which claims priority to Chinese Patent Application No. 202123056292.5 filed on Dec. 6, 2021. The disclosures of the aforementioned applications are hereby incorporated by reference in their entireties.

### TECHNICAL FIELD

The present application relates to the field of battery technology and, in particular, to an outer shell structure and a battery.

### BACKGROUND

With the advancement and development of science and technology, people's demands for wearable devices, such as wireless earphone, sports watch, bracelet and other electronic products are increasing, and wearable electronic products are more and more widely applied. Lithium-ion batteries have attracted much attention in the field of battery technology because of their low environmental pollution. Lithium-ion batteries mainly include stacked type and wound type. The stacked structure has advantages of high energy density, flexible shape and size, outstanding rate charge and discharge performance, and low charging temperature rise, and is becoming more and more important. Due to the miniaturization design of wearable devices, such products have high requirements for space size and performance of battery.

At present, a stacked battery mainly includes a bottom shell, a cover plate and a stacked battery cell assembly, the bottom shell is configured for accommodating the stacked battery cell assembly, the cover plate and the bottom shell are engaged to form an accommodation chamber accommodating the stacked battery cell assembly, the battery cell assembly is electrically connected with the bottom shell and the cover plate of the battery through a positive electrode tab and a negative electrode tab provided on the battery cell assembly. The bottom shell is integrally molded by stamping, the accommodation chamber is formed inside the bottom shell, and the positive electrode tab and the negative electrode tab are electrically connected to the bottom shell and the cover plate of the battery by riveting or polypropylene (Polypropylene, PP) butt fusion manner.

However, in the stacked battery in the prior art, the bottom shell is integrally formed by stamping, and due to the limitation of the stamping process, the size of a stamping angle formed at an outer periphery of the accommodation chamber of the bottom shell is larger. When the stacked battery cell assembly is placed in the accommodation chamber, there is a large space between its circumference and the stamping angle, which reduces the effective volume of the accommodation chamber of the battery without changing the internal system and battery volume, thereby not being conducive to the improvement of battery capacity.

### SUMMARY

An embodiment of the utility model provides an outer shell structure and a battery, which can improve the effective volume of an accommodation chamber of a battery and energy density of the battery.

The present utility model provides an outer shell structure for carrying an battery cell, including a cover plate, a bottom plate and a shell body, and each of two opposite ends of the shell body has an opening, the cover plate and the bottom plate cover on the two opposite sides of the shell body respectively; the cover plate, the shell body and the bottom plate together enclose to form an accommodation chamber for accommodating the battery cell; the outer shell structure includes a conductive assembly disposed on the shell body. It can be understood that each of a top end and a bottom end of the shell body has an opening, and openings at both ends are communicated to each other, the cover plate covers on the opening in the top end of the shell body, and the bottom plate covers on the opening in the bottom end of the shell body, and they enclose to form an accommodation chamber for accommodating the battery cell. The cover plate, the shell body and the bottom plate are welded in turn, so that the accommodation space of the accommodation chamber achieves maximum.

Through the above settings, for a given volume of a battery, the effective volume of the accommodation chamber of the battery can be increased, thereby increasing the capacity of the battery and increasing the energy density of the battery. This is used to solve the problem that in the prior art the size of a stamping angle formed at an outer periphery of the accommodation chamber is larger due to the limitation of the stamping process, which leads to a reduction in the effective volume of the accommodation chamber of the battery and thus leads to a smaller capacity of the battery.

As the aforesaid outer shell structure, optionally, the cover plate and the bottom plate are welded to the two opposite sides of the shell body respectively; a surface of a side of the cover plate facing away from the shell body is provided with a first welding seam, and/or a surface of a side of the bottom plate facing away from the shell body is provided with a second welding seam.

As the aforesaid outer shell structure, optionally, a depth of fusion of the first welding seam is greater than a thickness of the cover plate, and/or a depth of fusion of the second welding seam is greater than a thickness of the bottom plate.

As the aforesaid outer shell structure, optionally, a projection of the shell body onto the cover plate coincides with a projection of the first welding seam onto the cover plate, and/or a projection of the shell body onto the bottom plate coincides with a projection of the second welding seam onto the bottom plate.

As the aforesaid outer shell structure, optionally, a thickness of the cover plate is between 0.03-0.2 mm, a thickness of the shell body is between 0.2-0.4 mm, and a thickness of the bottom plate is between 0.04-0.2 mm.

It can be understood that the cover plate and the bottom plate can have a same plate thickness, or the plate thickness of the bottom plate is greater than that of the cover plate, and the thickness of the shell body is mainly changed according to the thickness of the battery cell. By setting the shell body having a larger thickness, the thickness of the cover plate and of the bottom plate can be reduced, thereby being beneficial to realize the lightweight of the outer shell structure, lower material cost, and being beneficial to increase the capacity of the battery at the same time.

As the aforesaid outer shell structure, optionally, the shell body is provided with a first through hole and a second through hole, and the first through hole and the second through hole are located at a same side of the shell body.

The conductive assembly includes a first tab conductive assembly and a second tab conductive assembly, the first tab conductive assembly is disposed outside an end face of the first through hole, and the second tab conductive assembly is disposed outside an end face of the second through hole.

It can be understood that a side wall of the shell body is provided with the first through hole and the second through hole, both of the first through hole and the second through hole penetrate through the side wall of the shell body, and the battery cell is placed in the accommodating chamber. By means of the first through hole and the second through hole, a first tab and a second tab of the battery cell pass through the first through hole and the second through hole respectively, and finally lead out from the interior of the shell body.

The first through hole and the second through hole are located on a same side of the side wall of the shell body, thereby being beneficial for the first tab and the second tab of the battery cell to pass through respectively.

As the aforesaid outer shell structure, optionally, the first tab conductive assembly includes a first conductive member and a second conductive member that are disposed on two opposite sides of the end face of the first through hole respectively; the first conductive member is connected to the second conductive member in a welding manner; the second tab conductive assembly includes a third conductive member and a fourth conductive member that are disposed on two opposite sides of the end face of the second through hole respectively; the third conductive member is connected to the fourth conductive member in a welding manner.

As the aforesaid outer shell structure, optionally, the second conductive member includes a first boss formed by protruding outward and a first extension portion formed by extending outward from a surface of the first boss; the first conductive member includes a first penetration through hole corresponding to the first extension portion; the first conductive member is connected to the first boss in a welding manner, and the first extension portion penetrates in the first penetration through hole; the fourth conductive member includes a second boss formed by protruding outward and a second extension portion formed by extending outward from a surface of the second boss; the third conductive member includes a second penetration through hole corresponding to the second extension portion; the third conductive member is connected to the second boss in a welding manner, and the second extension portion penetrates in the second penetration through hole.

As the aforesaid outer shell structure, optionally, the outer shell structure further includes an insulation assembly; the insulation assembly includes a first tab insulation assembly and a second tab insulation assembly, the first tab insulation assembly is disposed between the shell body and the first tab conductive assembly, and the second tab insulation assembly is disposed between the shell body and the second tab conductive assembly.

As the aforesaid outer shell structure, optionally, the first tab insulation assembly includes a first insulation member and a second insulation member, and the first insulation member is disposed between one end face of the first through hole and the first tab conductive assembly, the second insulation member is disposed between the other end face of the first through hole and the first tab conductive assembly; the first insulation member and the second insulation member are engaged and fixed outside the end faces of the first through hole.

The second tab insulation assembly includes a third insulation member and a fourth insulation member, the third insulation member is disposed between one end face of the second through hole and the second tab conductive assembly, the fourth insulation member is disposed between the other end face of the second through hole and the second tab conductive assembly; the third insulation member and the fourth insulation member are engaged and fixed outside the end faces of the second through hole.

As the aforesaid outer shell structure, optionally, the outer shell structure further includes a sealing sheet, the shell body is provided with a third through hole, and the sealing sheet is disposed outside an end face of the third through hole.

The sealing sheet is provided with a plurality of explosion-proof grooves, and a depth of each explosion-proof groove is less than a thickness of the sealing sheet.

It can be understood that the sealing sheet is provided on an end face of the third through hole, where a thickness of the sealing sheet is greater than a depth of each explosion-proof groove. When the depth of each explosion-proof groove is small, a surface of the explosion-proof groove and a surface of the sealing sheet can form a stepped structure resulting in a height difference.

As the aforesaid outer shell structure, optionally, the explosion-proof groove includes a first concave portion corresponding to a center of the sealing sheet and a second concave portion formed by extending from the center of the sealing sheet to an edge of the sealing sheet.

As the aforesaid outer shell structure, optionally, a third concave portion extending along an extending direction of the second concave portion is comprised within the second concave portion, the third concave portion is connected to the first concave portion, and a width of the third concave portion is less than a width of the second concave portion.

As the aforesaid outer shell structure, optionally, the explosion-proof groove has a shape of S-type, V-type, cross-type or X-type.

As the aforesaid outer shell structure, optionally, a concave depth of the first concave portion of the explosion-proof groove is greater than concave depths of the second concave portion and the third concave portion of the explosion-proof groove.

The present utility model further provides a battery, including a battery cell and the outer shell structure above, the battery cell is accommodated in the accommodation chamber, and the battery cell includes a first tab and a second tab, the first tab and the second tab are located on a same side of the battery cell.

The battery cell includes a stepped portion formed by protruding outward from a surface of a side of the battery cell where the first tab is located; each the first tab and the second tab both comprises a bent section; in a length direction of the battery cell, a plane in which the stepped portion lies protrudes beyond a plane in which the bent sections of the first tab and the second tab lie.

The battery has the beneficial effects brought by the above outer shell structure, which will not be repeated here.

For the outer shell structure and the battery provided by the present utility model, the battery includes an battery cell and the above shell structure, the battery cell is accommodated in an accommodating chamber, the battery cell includes a first tab and a second tab, the first tab and the second tab are located on a same side of the battery cell. The outer shell structure is configured for carrying the battery cell, and includes the cover plate, the bottom plate and the shell body, and each of two opposite ends of the shell body has an opening, the cover plate and the bottom plate cover on the two opposite sides of the shell body respectively; the cover plate, the shell body and the bottom plate together enclose to form an accommodation chamber for accommodating the battery cell; the outer shell structure includes a conductive assembly disposed on the shell body. Through the above settings, for a given volume of a battery, the effective volume of the accommodation chamber of the battery can be increased, thereby increasing the capacity of the battery and increasing the energy density of the battery. This is used to solve the problem that in the prior art the size of a stamping angle formed at an outer periphery of the accommodation chamber is larger due to the limitation of the stamping process, which leads to a reduction in the effective volume of the accommodation chamber of the battery and thus leads to a smaller capacity of the battery.

### BRIEF DESCRIPTION OF DRAWINGS

To illustrate the technical solutions in embodiments of the present utility model or in the prior art more clearly, the following briefly introduces the accompanying drawings required for describing the embodiments or the prior art. Apparently, the accompanying drawings in the following description illustrate merely some embodiments of the present utility model, and persons of ordinary skill in the art may still derive other drawings from these accompanying drawings without creative effort.

FIG. 1 is a structural schematic diagram of a battery provided in an embodiment of the present application.

FIG. 2 is an exploded schematic diagram of a battery provided in an embodiment of the present application.

FIG. 3 is a structural schematic diagram of a shell body in a battery provided in an embodiment of the present application.

FIG. 4 is a partial enlarged structural schematic diagram of I in FIG. 3.

FIG. 5 is a structural schematic diagram of a sealing sheet in a battery under a first perspective provided in an embodiment of the present application.

FIG. 6 is a structural schematic diagram of a sealing sheet in a battery under a second perspective provided in an embodiment of the present application.

FIG. 7 is a cross-section diagram of a shell body in a battery under a first perspective provided in an embodiment of the present application.

FIG. 8 is a cross-section diagram of a shell body in a battery under a second perspective provided in an embodiment of the present application.

### DESCRIPTION OF REFERENCE NUMBERS

1-cover plate;
2-bottom plate;
3-shell body;
10-outer shell structure;
20-battery cell;
21-first tab;
22-second tab;
31-first through hole;
32-second through hole;
33-third through hole;
4-first tab conductive assembly;
41-first conductive member;
42-second conductive member;
5-second tab conductive assembly;
51-third conductive member;
52-fourth conductive member;
6-first tab insulation assembly;
61-first insulation member;
62-second insulation member;
7-second tab insulation assembly;
71-third insulation member;
72-fourth insulation member;
8-sealing sheet;
81-explosion-proof groove;
100-battery.

### DESCRIPTION OF EMBODIMENTS

To make the objectives, technical solutions, and advantages of embodiments of the present utility model clearer, the following clearly and comprehensively describes the technical solutions in embodiments of the present utility model with reference to the accompanying drawings in embodiments of the present utility model. Apparently, the described embodiments are merely a part rather than all embodiments of the present utility model. All other embodiments obtained by persons of ordinary skill in the art based on embodiments of the present utility model without creative effort shall fall within the protection scope of the present utility model. All other obtained embodiments belong to the protection scope of the present utility model. The following embodiments and the features in the embodiments can be combined with each other without conflict.

In the description of the present utility model, it is to be understood that the terms “center”, “longitudinal”, “transverse”, “length”, “width”, “thickness”, “up”, “down”, “front”, “back”, “left”, “right”, “vertical”, “horizontal”, “top”, “bottom”, “inside”, “outside”, “clockwise”, “counterclockwise”, “axial”, “radial”, “circumferential”, etc. indicate the orientation or position relationship based on the orientation or position relationship shown in the accompanying drawings, only to facilitate the description of the present utility model and simplify the description, and not to indicate or imply that the device or assembly referred to must have a specific orientation, be constructed and operated in a specific orientation, and therefore cannot be interpreted as a limitation to the present utility model.

In the present utility model, unless otherwise expressly specified and limited, the terms “mounted”, “linked”, “connected”, “fixed”, etc. shall be understood in a broad sense, for example, the connection may be fixed connection, detachable connection, integrated connection, direct connection, indirect connection by an intermediate medium, interconnection between the interiors of two components, or an interaction relationship between two components. For persons of ordinary skill in the art, the specific meanings of the aforesaid terms in the present utility model can be understood based on the specific situations.

It should be noted that in the description of the present utility model, the terms “first” and “second” are only used to facilitate the description of different components and are not to be understood as indicating or implying a sequential relationship, relative importance, or implicitly specifying the number of the indicated technical features. Thus, the features defined with “first” and “second” may explicitly or implicitly include at least one such feature.

In prior art, a stacked battery mainly includes a bottom shell, a cover plate and a stacked battery cell assembly, the bottom shell is configured for accommodating the stacked battery cell assembly, the cover plate and the bottom shell are engaged to form an accommodation chamber accommodating the stacked battery cell assembly, the battery cell assembly is electrically connected with the bottom shell and the cover plate of the battery through a positive electrode tab and a negative electrode tab provided on the battery cell assembly. The bottom shell is integrally molded by stamping, the accommodation chamber is formed inside the bottom shell, and the positive electrode tab and the negative electrode tab are electrically connected to the bottom shell and the cover plate of the battery by riveting or polypropylene (Polypropylene, PP) butt fusion manner. However, in the stacked battery in the prior art, the bottom shell is integrally formed by stamping, and due to the limitation of the stamping process, the size of a stamping angle formed at an outer periphery of the accommodation chamber of the bottom shell is larger. When the stacked battery cell assembly is placed in the accommodation chamber, there is a large space between its circumference and the stamping angle, which reduces the effective volume of the accommodation chamber of the battery without changing the internal system and battery volume, thereby not being conducive to the improvement of battery capacity.

In order to overcome the defects in the prior art, the present utility model provides an outer shell structure and a battery, where a cover plate, a shell body and a bottom plate together enclose to form an accommodation chamber for accommodating a battery cell. Through the above settings, for a given volume of a battery, the effective volume of the accommodation chamber of the battery can be increased, thereby increasing the capacity of the battery and increasing the energy density of the battery. This is used to solve the problem that in the prior art the size of a stamping angle formed at an outer periphery of the accommodation chamber is larger due to the limitation of the stamping process, which leads to a reduction in the effective volume of the accommodation chamber of the battery and thus leads to a smaller capacity of the battery.

The content of the present utility model will be described in detail below in conjunction with the accompanying drawings, so that persons of ordinary skill in the art can understand the content of the utility model more clearly and detailedly.

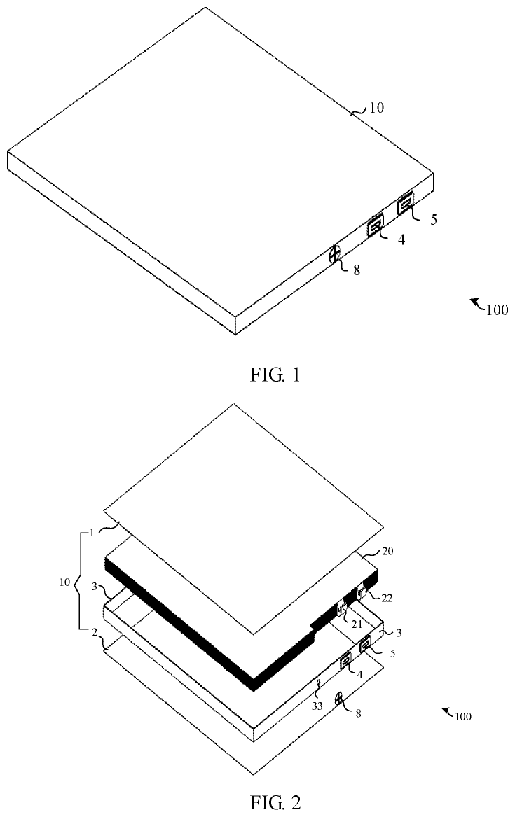

FIG. 1 is a structural schematic diagram of a battery provided in an embodiment of the present application, and FIG. 2 is an exploded schematic diagram of a battery provided in an embodiment of the present application. As shown in FIG. 1 and FIG. 2, an embodiment of the present application provides a shell structure 10 for carrying a battery cell 20, including a cover plate 1, a bottom plate 2, and a shell body 3, each of two opposite ends of the shell body 3 has an opening, the cover plate 1 and the bottom plate 2 cover on the two opposite sides of the shell body 3 respectively; the cover plate 1, the shell body 3 and the bottom plate 2 together enclose to form an accommodation chamber for accommodating the battery cell 20; the outer shell structure 10 includes a conductive assembly disposed on the shell body 3.

It can be understood that both a top end and a bottom end of the shell body 3 have openings, respectively, and the openings at both ends are communicated with each other, the cover plate 1 covers on the opening in the top end of the shell body 3, and the bottom plate 2 covers on the opening in the bottom end of the shell body 3, and they enclose to form the accommodation chamber for accommodating the battery cell 20. The cover plate 1, the shell body 3 and the bottom plate 2 are welded in turn, so that the accommodation space of the accommodation chamber achieves maximum.

Through the above settings, for a given volume of the battery 100, the effective volume of the accommodation chamber of the battery 100 can be increased, thereby increasing the capacity of the battery 100 and increasing the energy density of the battery 100, which is used to solve the problem that in the prior art the size of a stamping angle formed at an outer periphery of the accommodation chamber is larger due to the limitation of the stamping process, which leads to a reduction in the effective volume of the accommodation chamber of the battery 100 and thus leads to a smaller capacity of the battery 100.

In some examples, the cover plate 1 can be fastened to and welded to the opening of the top end of the shell body 3, and the bottom plate 2 can be fastened to and welded to the opening of the bottom end of the shell body 3.

It can be understood that the cover plate 1, the shell body 3 and the bottom plate 2 together enclose to form the accommodation chamber for accommodating the battery cell 20, the conductive assembly is disposed on the shell body 3, and the conductive assembly is electrically connected to a tab of the battery cell 20, so as to lead the electric power generated by the tab out through conductive assembly.

The size of the above outer shell structure 10 can be set according to actual needs.

In some possible implementations, the cover plate 1 and the bottom plate 2 are respectively welded to two opposite sides of the shell body 3; a surface of a side of the cover plate 1 facing away from the shell body 3 is provided with a first welding seam, and/or a surface of a side of the bottom plate 2 facing away from the shell body 3 is provided with a second welding seam.

It can be understood that the first welding seam can enhance the welding strength between the cover plate 1 and the shell body 3, and similarly, the second welding seam can enhance the welding strength between the bottom plate 2 and the shell body 3.

Specifically, the cover plate 1 is in sealing connection with the shell body 3, the bottom plate 2 and the shell body 3 can be in sealing connection with each other by welding, or can be in sealing connection with each other by a fastener, and the specific connection methods are not limited.

The cover plate 1, the shell body 3 and the bottom plate 2 are all single-layer plates, and are in sealing connection with each other, so that in a given volume of the battery 100, the effective volume of the accommodation chamber of the battery 100 can be increased, thereby increasing the capacity of the battery 100 and increasing the energy density of the battery 100.

In some possible implementations, a depth of fusion of the first welding seam is greater than a thickness of the cover plate 1, and/or a depth of fusion of the second welding seam is greater than a thickness of the bottom plate 2.

It can be understood that the depth of fusion of the first weld is greater than the thickness of the cover plate 1 and the depth of fusion of the second weld is greater than the thickness of the bottom plate 2; or the depth of fusion of the first weld is greater than the thickness of the cover plate 1 or the depth of fusion of the second weld is greater than the thickness of the bottom plate 2.

In some possible implementations, a projection of the shell body 3 on the cover plate 1 coincides with a projection of the first welding seam on the cover plate 1, and/or a projection of the shell body 3 on the bottom plate 2 coincides with a projection of the second welding seam on the bottom plate 2.

It can be understood that the projection of the shell body 3 on the cover plate 1 coincides with the projection of the first weld on the cover plate 1 and the projection of the shell body 3 on the bottom plate 2 coincides with the projection of the second welding seam on the bottom plate 2; the projection of the shell body 3 on the cover plate 1 coincides with the projection of the first weld on the cover plate 1 or the projection of the shell body 3 on the bottom plate 2 coincides with the projection of the second welding seam on the bottom plate 2.

In some possible implementations, a thickness of the cover plate 1 is between 0.03-0.2 mm, a thickness of the shell body 3 is between 0.2-0.4 mm, and a thickness of the bottom plate 2 is 0.04-0.2 mm.

It can be understood that the cover plate 1 and the bottom plate 2 can be configured to have a same plate thickness, or the plate thickness of the bottom plate 2 is greater than that of the cover plate 1, and the thickness of the shell body 3 is mainly changed according to the thickness of the battery cell 20. By setting the shell body 3 having a larger thickness, the thickness of the cover plate 1 and the thickness of the bottom plate 2 can be reduced, thereby being beneficial to realize the lightweight of the outer shell structure 10, lower material cost, and being beneficial to increase the capacity of the battery 100 at the same time.

It can be understood that both the cover plate 1 and the bottom plate 2 are made of stainless steel material having strong corrosion resistance.

It can be understood that the material of the conductive assembly is stainless steel.

In some examples, the cover plate 1, the bottom plate 2 and the conductive assembly may be conductive structures made of the same metal material, or the cover plate 1, the bottom plate 2 and the conductive assembly may be conductive structures made of two different metal materials.

That is to say, the material of the cover plate 1, the bottom plate 2 and the conductive assembly can be the same or different, they can be of metal in a same material, or they can be of metal in different materials. Further, one of them can be of metal material and the other of them can be of non-metal material. For example, the material of the conductive assembly is the same as that of the cover plate 1 and of the bottom plate 2, and they are all of stainless steel. For another example, the material of the cover plate 1 and of the bottom plate 2 is stainless steel, and the material of the conductive assembly is copper. Of course, the cover plate 1, the bottom plate 2 and the conductive assembly can also be made of other material, and there is no limitation on specific material. Generally, the cover plate 1 and the bottom plate 2 are made of stainless steel material having strong corrosion resistance.

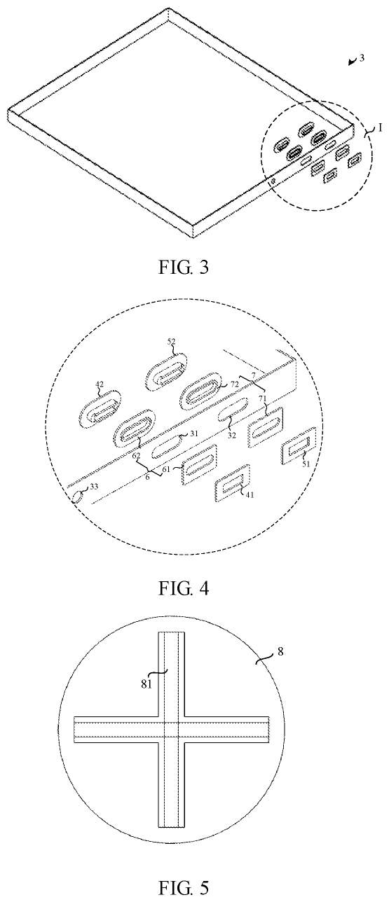

In some possible implementations, FIG. 3 is a structural schematic diagram of a shell body in a battery provided in an embodiment of the present application, FIG. 4 is a partial enlarged structural schematic diagram of I in FIG. 3, FIG. 7 is a cross-section diagram of a shell body in a battery under a first perspective provided in an embodiment of the present application, and FIG. 8 is a cross-section diagram of a shell body in a battery under a second perspective provided in an embodiment of the present application. As shown in FIG. 3 and FIG. 4 as well as FIG. 7 and FIG. 8, the shell body 3 is provided with a first through hole 31 and a second through hole 32, and the first through hole 31 and the second through hole 32 are located at a same side of the shell body 3.

The conductive assembly includes a first tab conductive assembly 4 and a second tab conductive assembly 5, the first tab conductive assembly 4 is disposed outside an end face of the first through hole 31, and the second tab conductive assembly 5 is disposed outside an end face of the second through hole 32.

It can be understood that, as shown in FIGS. 2-4, a side wall of the shell body 3 is provided with the first through hole 31 and the second through hole 32, both of the first through hole 31 and the second through hole 32 penetrate through the side wall of the shell body 3, and the battery cell 20 is placed in the accommodating chamber, and by means of the first through hole 31 and the second through hole 32, a first tab 21 and a second tab 22 of the battery cell 20 respectively pass through the first through hole 31 and the second through hole 32, and finally lead out from an interior of the shell body 3.

The first through hole 31 and the second through hole 32 are located on a same side of the side wall of the shell body 3, thereby being beneficial for the first tab 21 and the second tab 22 of the battery cell 20 to pass through respectively.

The first tab conductive assembly 4 is disposed outside the end face of the first through hole 31, and is electrically connected to the first tab 21 of the battery cell 20; the second tab conductive assembly 5 is disposed outside the end face of the second through hole 32, and is electrically connected to the second tab 22 of the battery cell 20.

In some possible implementations, as shown in FIGS. 2-4, the first tab conductive assembly 4 includes a first conductive member 41 and a second conductive member 42 respectively disposed on two opposite sides of the end face of the first through hole 31, the first conductive member 41 is connected to the second conductive member 42 in a welding manner, the second tab conductive assembly 5 includes a third conductive member 51 and a fourth conductive member 52 respectively disposed on two opposite sides of the end face of the second through hole 32, the third conductive member 51 is connected to the fourth conductive member 52 in a welding manner.

In some possible implementations, as shown in FIGS. 2-4, the second conductive member 42 includes a first boss formed by protruding outward and a first extension portion formed by extending outward from a surface of the first boss; the first conductive member 41 includes a first penetration through hole corresponding to the first extension portion, the first conductive member 41 is connected to the first boss in a welding manner, the first extension portion penetrates in the first penetration through hole; and the fourth conductive member 52 includes a second boss formed by protruding outward and a second extension portion formed by extending outward from a surface of the second boss; the third conductive member 51 includes a second penetration through hole corresponding to the second extension portion, the third conductive members 51 is connected to the second boss in a welding manner, and the second extension portion penetrates in the second penetration through hole.

In some possible implementations, as shown in FIGS. 2-4, the outer shell structure 10 further includes an insulation assembly, the insulation assembly includes a first tab insulation assembly 6 and a second tab insulation assembly 7, the first tab insulation assembly 6 is disposed between the shell body 3 and the first tab conductive assembly 4, and the second tab insulation assembly 7 is disposed between the shell body 3 and the second tab conductive assembly 5.

It can be understood that the provision of the first tab insulation assembly 6 between the shell body 3 and the first tab conductive assembly 4 is used to avoid the shell body 3 from contacting the first tab conductive assembly 4; the provision of the second tab insulation assembly 7 between the shell body 3 and the second tab conductive assembly 5 is used to avoid the shell body 3 from contacting the second tab conductive assembly 5.

In some embodiments, the first tab insulation assembly 6 and the second tab insulation assembly 7 are of insulation material, both of them can be of single insulation material, or can be of mixture of multiple insulation materials, and the material thereof can be non-metal material such as rubber, resin, and polypropylene, specific insulation materials are not limited to the above several materials, and are also other materials.

Of course, for example, the material of the first tab insulation assembly 6 can include silicon dioxide. Since silicon dioxide has superior stability, adsorption force and strong hardness, it can be well connected together to the shell body 3 and the first tab conductive assembly 4.

Similarly, the material of the second tab insulation assembly 7 may also include silicon dioxide. Since silicon dioxide has superior stability, adsorption force and strong hardness, it can be well connected together to the shell body 3 and the second tab conductive assembly 5.

In addition, the material of the first tab insulation assembly 6 further can include ceramics. Since ceramic material has the advantages of high melting point, high hardness, high wear resistance and oxidation resistance, it can form an integrated structure with the shell body 3 and the first tab conductive assembly 4 by subjecting a natural or synthetic compound to forming and sintering at high temperature, which can effectively ensure the connection strength.

Similarly, the material of the second tab insulation assembly 7 can also include ceramics, and it can form an integrated structure with the shell body 3 and the second tab conductive assembly 5 by subjecting a natural or synthetic compound to forming and sintering at high temperature, which can effectively ensure the connection strength.

In some possible implementations, as shown in FIGS. 2-4, the first tab insulation assembly 6 includes a first insulation member 61 and a second insulation member 62, and the first insulation member 61 is disposed between one end face of the first through hole 31 and the first tab conductive assembly 4, the second insulation member 62 is disposed between the other end face of the first through hole 31 and the first tab conductive assembly 4; the first insulation member 61 and the second insulation member 62 are engaged and fixed outside the end faces of the first through hole 31.

The second tab insulation assembly 7 includes a third insulation member 71 and a fourth insulation member 72, the third insulation member 71 is disposed between one end face of the second through hole 32 and the second tab conductive assembly 5, the fourth insulation member 72 is disposed between the other end face of the second through hole 32 and the second tab conductive assembly 5; the third insulation member 71 and the fourth insulation member 72 are engaged and fixed outside the end faces of the second through hole 32.

It can be understood that, as shown in FIGS. 2-4, the first through hole 31 is disposed in the side wall of the shell body 3, the first conductive member 41 and the first insulation member 61 are both located at one side of the first through hole 31, that is, are both located outside the shell body 3, the fourth insulation member 71 and the fourth conductive member 52 are both located at the other side of the first through hole 31, that is, are both located inside the shell body 3.

It can be understood that the second through hole 32 is disposed in the side wall of the shell body 3, the third conductive member 51 and the third insulation member 71 are both located at one side of the second through hole 32, that is, are both located outside the shell body 3, the fourth insulation member 72 and the fourth conductive member 52 are both located at the other side of the second through hole 32, that is, are both located inside the shell body 3.

In some embodiments, each of the first conductive member 41, the first insulation member 61, the second insulation member 62 and the second conductive member 42 is hollow structure for the first tab 21 of the battery cell 20 to extend out.

Similarly, in some embodiments, each of the third conductive member 51, the third insulation member 71, the fourth insulation member 72 and the fourth conductive member 52 is hollow structure for the second tab 22 of the battery cell 20 to extend out.

In some examples, each of the first tab conductive assembly 4, the second tab conductive assembly 5, the first tab insulation assembly 6, and the second tab insulation assembly 7 may be circular ring hollow structure, oval hollow structure, and may also be square hollow structure, polygonal hollow structure and irregular hollow structure; the first tab conductive assembly 4, the second tab conductive assembly 5, the first tab insulation assembly 6 and the second tab insulation assembly 7 can have various shapes, and specific shapes are not limited.

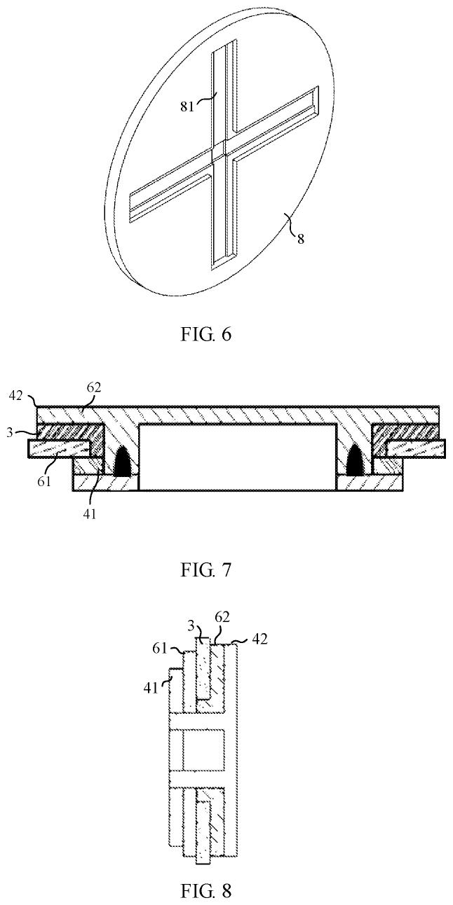

In some possible implementations, FIG. 5 is a structural schematic diagram of a sealing sheet in a battery under a first perspective provided in an embodiment of the present application, and FIG. 6 is a structural schematic diagram of a sealing sheet in a battery under a second perspective provided in an embodiment of the present application, as shown in FIGS. 5 and 6, the outer shell structure 10 further includes a sealing sheet 8, the shell body 3 is provided with a third through hole 33, the sealing sheet 8 is disposed outside an end face of the third through hole 33, and the sealing sheet 8 is provided with a plurality of explosion-proof grooves 81, and the depth of each explosion-proof groove 81 is less than the thickness of the sealing sheet 8.

It can be understood that the sealing sheet 8 covers on the end face of the third through hole 33, where the thickness of the sealing sheet 8 is greater than the depth of the explosion-proof groove 81. When the depth of the explosion-proof groove 81 is small, a surface of each explosion-proof groove 81 and a surface of the sealing sheet 8 can form a stepped structure resulting in a height difference, as shown in FIG. 6.

Specifically, in the case of low pressure of the battery 100, the gas produced inside the battery 100 is discharged in time through the sealing sheet 8 to prevent the accumulation of gas produced inside the battery 100. When the interior of the battery 100 occurs abnormalities due to short-circuit and so on, the rapid rise in temperature is accompanied with a rapid rise in pressure, and when the internal pressure of the battery 100 rises to a certain value, an explosion-proof valve is easy to be ruptured due to the thickness of the explosion-proof valve is less than the thickness of the sealing piece 8, so as to achieve the purpose of pressure relief, thereby preventing the battery 100 from exploding due to excessive internal pressure.

In some possible implementations, the explosion-proof groove 81 includes a first concave portion corresponding to a center of the sealing sheet 8 and a second concave portion formed by extending from the center of the sealing sheet 8 to an edge of the sealing sheet 8.

It can be understood that, as shown in FIGS. 5 and 6, a plurality of explosion-proof grooves 81 form an explosion-proof valve. Generally, the explosion-proof valve is completed through three laser processes including a first engraving process, a second engraving process, and a third engraving process. At this time, a plurality of laser processes form the plurality of explosion-proof grooves 81.

In some possible implementations, the second recessed portion includes a third concave portion extending along an extension direction of the second concave portion, the third concave portion is connected to the first concave portion, and a width of the third concave portion is less than a width of the second concave portion.

In some possible implementations, the shape of the explosion-proof groove is an S-type, V-type, straight-type, curve-type, cross-type or X-type.

In some examples, the explosion-proof groove 81 is S-type, V-type, straight-type, curve-type, cross-type or X-type in shape. The explosion-proof valve formed therein is “cross-type” or “pozidriv-type” or other types. A nick at the crossing is the deepest, and a nick at the periphery is the shallowest. When detonating, the center of the crossing explodes and extends to the periphery, which can release the pressure quickly.

In some possible implementations, a concave depth of the first concave portion of the explosion-proof groove 81 is greater than concave depths of the second concave portion and the third concave portion of the explosion-proof groove 81.

It can be understood that the concave depth of the first concave portion is greater than the concave depth of the second concave portion. The explosion-proof valve in present embodiment is thicker relative to ordinary explosion-proof membranes, which is convenient for production, is not easy to damage during transportation, and is easy to control the explosion-proof pressure.

The outer shell structure provided by an embodiment of the present application is used for carrying the battery cell, and includes a cover plate, a bottom plate, and a shell body, each of two opposite ends of the shell body has an opening, the cover plate and the bottom plate covers on the two opposite sides of the shell body respectively; the cover plate, the shell body and the bottom plate together enclose to form an accommodation chamber for accommodating the battery cell; the outer shell structure includes a conductive assembly disposed on the shell body. Through the above settings, for a given volume of a battery, the effective volume of the accommodation chamber of the battery can be increased, thereby increasing the capacity of the battery and increasing the energy density of the battery. This is used to solve the problem that in the prior art the size of a stamping angle formed at an outer periphery of the accommodation chamber is larger due to the limitation of the stamping process, which leads to a reduction in the effective volume of the accommodation chamber of the battery and thus leads to a smaller capacity of the battery.

An embodiment of the present application further provides a battery 100, including the battery cell 20 and the above outer shell structure 10, the battery cell 20 is accommodated in the accommodation chamber, the battery cell 20 includes a first tab 21 and a second tab 22, the first tab 21 and the second tab 22 are located on a same side of the battery cell 20.

As the aforesaid battery 100, optionally, the battery cell 20 includes a stepped portion formed by protruding outward from a surface of a side of the battery cell 20 where the first tab 21 is located; each of the first tab 21 and the second tab 22 includes a bent section; in the length direction of the battery cell 20, a plane in which the stepped portion lies protrudes beyond a plane in which the bent sections of the first tab 21 and of the second tab 22 lie.

The battery 100 has the beneficial effects brought by the above outer shell structure 10, which will not be repeated here.

The battery provided in an embodiment of the present application includes an battery cell and the above outer shell structure, the battery cell is accommodated in the accommodation chamber, the battery cell includes the first tab and the second tab, the first tab and the second tab are located on a same side of the battery cell. The outer shell structure, for carrying the battery cell, includes a cover plate, a bottom plate, and a shell body, each of two opposite ends of the shell body has an opening, the cover plate and the bottom plate cover on the two opposite sides of the shell body respectively; the cover plate, the shell body and the bottom plate together enclose to form an accommodation chamber for accommodating the battery cell. The outer shell structure includes a conductive assembly disposed on the shell body. Through the above settings, for a given volume of a battery, the effective volume of the accommodation chamber of the battery can be increased, thereby increasing the capacity of the battery and increasing the energy density of the battery. This is used to solve the problem that in the prior art the size of a stamping angle formed at an outer periphery of the accommodation chamber is larger due to the limitation of the stamping process, which leads to a reduction in the effective volume of the accommodation chamber of the battery and thus leads to a smaller capacity of the battery.

Finally, it should be noted that the foregoing embodiments are merely intended for describing the technical solutions of the present utility model other than limiting the present invention. Although the present utility model is described in detail with reference to the foregoing embodiments, persons of ordinary skill in the art should understand that they may still make modifications to the technical solutions described in the foregoing embodiments or make equivalent substitutions to some or all technical features thereof, and these modifications or substitutions do not make the essence of corresponding technical solutions depart from the scope of the technical solutions of embodiments of the present utility model.

What is claimed is:

1. A outer shell structure for carrying an battery cell, comprising a cover plate, a bottom plate, and a shell body, and each of two opposite ends of the shell body has an opening, the cover plate and the bottom plate cover on the two opposite sides of the shell body respectively;
the cover plate, the shell body and the bottom plate together enclose to form an accommodation chamber for accommodating the battery cell;
the outer shell structure comprises a conductive assembly disposed on the shell body.

2. The outer shell structure according to claim 1, wherein the cover plate and the bottom plate are welded to the two opposite sides of the shell body respectively;
a surface of a side of the cover plate facing away from the shell body is provided with a first welding seam, and/or a surface of a side of the bottom plate facing away from the shell body is provided with a second welding seam.

3. The outer shell structure according to claim 2, wherein a depth of fusion of the first welding seam is greater than a thickness of the cover plate, and/or a depth of fusion of the second welding seam is greater than a thickness of the bottom plate.

4. The outer shell structure according to claim 2, wherein a projection of the shell body onto the cover plate coincides with a projection of the first welding seam onto the cover plate, and/or a projection of the shell body onto the bottom plate coincides with a projection of the second welding seam onto the bottom plate.

5. The outer shell structure according to claim 1, wherein a thickness of the cover plate is between 0.03-0.2 mm, a thickness of the shell body is between 0.2-0.4 mm, and a thickness of the bottom plate is between 0.04-0.2 mm.

6. The outer shell structure according to claim 1, wherein the shell body is provided with a first through hole and a second through hole, and the first through hole and the second through hole are located at a same side of the shell body;
the conductive assembly comprises a first tab conductive assembly and a second tab conductive assembly, the first tab conductive assembly is disposed outside an end face of the first through hole, and the second tab conductive assembly is disposed outside an end face of the second through hole.

7. The outer shell structure according to claim 6, wherein the first tab conductive assembly comprises a first conductive member and a second conductive member that are disposed on two opposite sides of the end face of the first through hole respectively;
the first conductive member is connected to the second conductive member in a welding manner;
the second tab conductive assembly comprises a third conductive member and a fourth conductive member that are disposed on two opposite sides of the end face of the second through hole respectively;
the third conductive member is connected to the fourth conductive member in a welding manner.

8. The outer shell structure according to claim 7, wherein the second conductive member comprises a first boss formed by protruding outward and a first extension portion formed by extending outward from a surface of the first boss;
the first conductive member comprises a first penetration through hole corresponding to the first extension portion;
the first conductive member is connected to the first boss in a welding manner, and the first extension portion penetrates in the first penetration through hole;
the fourth conductive member comprises a second boss formed by protruding outward and a second extension portion formed by extending outward from a surface of the second boss;
the third conductive member comprises a second penetration through hole corresponding to the second extension portion;
the third conductive member is connected to the second boss in a welding manner, and the second extension portion penetrates in the second penetration through hole.

9. The outer shell structure according to claim 6, wherein
the outer shell structure further comprises an insulation assembly;
the insulation assembly comprises a first tab insulation assembly and a second tab insulation assembly, the first tab insulation assembly is disposed between the shell body and the first tab conductive assembly, and the second tab insulation assembly is disposed between the shell body and the second tab conductive assembly.

10. The outer shell structure according to claim 9, wherein the first tab insulation assembly comprises a first insulation member and a second insulation member, and the first insulation member is disposed between one end face of the first through hole and the first tab conductive assembly, the second insulation member is disposed between the other end face of the first through hole and the first tab conductive assembly; the first insulation member and the second insulation member are engaged and fixed outside the end faces of the first through hole;
the second tab insulation assembly comprises a third insulation member and a fourth insulation member, the third insulation member is disposed between one end face of the second through hole and the second tab conductive assembly, the fourth insulation member is disposed between the other end face of the second through hole and the second tab conductive assembly; the third insulation member and the fourth insulation member are engaged and fixed outside the end faces of the second through hole.

11. The outer shell structure according to claim 1, further comprising a sealing sheet, and the shell body is provided with a third through hole, and the sealing sheet is disposed outside an end face of the third through hole;
the sealing sheet is provided with a plurality of explosion-proof grooves, and a depth of each of the explosion-proof grooves is less than a thickness of the sealing sheet.

12. The outer shell structure according to claim 11, wherein each of the explosion-proof grooves comprises a first concave portion corresponding to a center of the sealing sheet and a second concave portion formed by extending from the center of the sealing sheet to an edge of the sealing sheet.

13. The outer shell structure according to claim 12, wherein
a third concave portion extending along an extending direction of the second concave portion is comprised within the second concave portion, the third concave portion is connected to the first concave portion, and a width of the third concave portion is less than a width of the second concave portion.

14. The outer shell structure according to claim 11, wherein each of the explosion-proof grooves has a shape of S-type, V-type, cross-type or X-type.

15. The outer shell structure according to claim 13, wherein a concave depth of the first concave portion of each of the explosion-proof grooves is greater than concave depths of the second concave portion and the third concave portion of each of the explosion-proof grooves.

16. The outer shell structure according to claim 6, wherein the first tab conductive assembly is electrically connected to a first tab of the battery cell; and the second tab conductive assembly is electrically connected to a second tab of the battery cell.

17. The outer shell structure according to claim 9, wherein the first tab insulation assembly forms an integrated structure with the shell body and the first tab conductive assembly; and the second tab insulation assembly forms an integrated structure with the shell body and the second tab conductive assembly.

18. The outer shell structure according to claim 10, wherein each of the first conductive member, the first insulation member, the second insulation member and the second conductive member is hollow structure to make the first tab of the battery cell extend out; and each of the third conductive member, the third insulation member, the fourth insulation member and the fourth conductive member is hollow structure to make the second tab of the battery cell extend out.

19. A battery, comprising a battery cell and the outer shell structure according to claim 1, the battery cell is accommodated in the accommodation chamber, and the battery cell comprises a first tab and a second tab, the first tab and the second tab are located on a same side of the battery cell.

20. The battery according to claim 19, wherein the battery cell comprises a stepped portion formed by protruding outward from a surface of a side of the battery cell where the first tab is located;
each of the first tab and the second tab comprises a bent section;
in a length direction of the battery cell, a plane in which the stepped portion lies protrudes beyond a plane in which the bent sections of the first tab and the second tab lie.
